(19) United States
(12) Patent Application Publication
(10) Pub. No.: US 2014/0287112 A1
(43) Pub. Date: Sep. 25, 2014

(54) DEVICE AND METHOD FOR PRODUCING FOODS

(71) Applicant: Bernhard Hukelmann, Quakenbrueck (DE)

(72) Inventor: Bernhard Hukelmann, Quakenbrueck (DE)

(73) Assignee: DEUTSCHES INSTITUT FUER LEBENSMITTELTECHNIK E.V., Quakenbrueck (DE)

(21) Appl. No.: 14/238,092

(22) PCT Filed: Aug. 3, 2012
(86) PCT No.: PCT/EP2012/065300

§ 371 Date: Apr. 30, 2014

(30) Foreign Application Priority Data
Aug. 11, 2011 (DE) 102011080860.4

(51) Int. Cl. H05B 3/00; A23L 1/01

(52) U.S. Cl. CPC H05B 3/0004; A23L 1/0128
USPC 426/244; 219/771

(57) ABSTRACT

The invention relates to a device for treating raw materials, comprising at least two spaced-apart electrodes, which electrodes are in contact with a controlled electrical energy source, wherein the electrodes are each formed by at least two electrically separated electrode segments of which each segment is electrically connected to the electrical energy source in a controlled manner and each electrode segment is connected to a measuring apparatus designed to determinate the electrical conductivity between electrode segments, wherein the electrical energy source is controlled by a control unit and the electrical energy source is controlled and is set up to respectively apply electrical energy at least to the two electrode segments between which the lowest electrical conductivity is determined.

The present invention concerns a device and a method which are adapted for the treatment of raw materials with electrical power, in particular of foodstuff raw materials for producing foodstuffs, in particular for batchwise or continuous heating-up of foodstuff raw materials. Preferably, the invention relates to an apparatus and a method for producing foodstuffs, in particular meats and sausages or pasta products, for instance bread dough, by applying electric energy batchwise or continuously, in particular for heating-up by means of alternate or direct current up to a predetermined temperature and/or for partial cell breakdown and/or for germ reduction by means of high-voltage pulses. The apparatus is characterised in that it enables uniform application of electric energy in foodstuff raw materials through their cross-section or volumes within a short time.

### STATE OF THE ART

Document DE 3214861 A1 describes an apparatus with two spaced apart plate electrodes, on which contact plates impregnated with salt solution lie, for heating-up a comestible good packed in a film.

Document DE 3730042 A1 describes the cooking of foodstuff pieces between two spaced-apart and powered-up electrodes wherein the current is measured as a benchmark of the achieved heating process to determine the cooking time.

Document DE 3419419 describes the heating process of foodstuffs between electrodes, one of which uses salt water as a conductor, with control of the current supply via a measured temperature.

Document DE 36 21 999 describes the measurement of the cooking condition by means of a powered-up conductivity sensor.

### OBJECT OF THE INVENTION

The object of the invention is to provide an alternative apparatus and an alternative method for producing foodstuffs which enable an approximately uniform heating-up of foodstuffs.

### GENERAL DESCRIPTION OF THE INVENTION

During the preparation of the invention, it was found that upon heating-up of foodstuffs between two spaced-apart and powered-up electrodes, the heating process originates from a more or less linear current pathway through the foodstuff and a relatively long period of current flow is necessary to heat up the whole cross-section of the foodstuff. Therein it was observed that essentially only a filiform pathway is formed between the electrodes, a pathway along which the foodstuff is heated up. Said heating-up increases the conductance further so that the original current pathway between two electrodes receives a greater conductivity with increasing duration of application of current and accordingly more current flows essentially along said single current pathway between two electrodes. Subsequently, the amperage can only be increased gradually since the warmth propagates essentially by thermal conduction along said single current pathway. Suitable foodstuff raw materials are masses for meats and sausages, for instance pieces of meat or sausage meat, as well as dough for pastries, for example dough on the basis of cereal products, in particular flour, in particular bread dough.

The invention provides a device and a resulting method for applying electric energy to raw materials, in particular foodstuff raw materials or foodstuffs, according to the claims, which enables to achieve a faster and more uniform treatment of the foodstuff raw material or of the foodstuff over the whole volume thereof or over the whole cross-section thereof, by the spaced-apart electrodes being subdivided into electrode segments which are insulated from each other or spaced apart from one other and electric energy is applied respectively to those electrode segments, between which a small conductance, preferably the smallest conductance, is determined with respect to the conductance, which is determined between other electrode segments, wherein preferably each conductance is determined as a conductivity with respect to the distance of the respective electrode segments, even more preferably with respect to the distance and to the surface of the respective electrode segments. Accordingly, electric energy is applied to the electrode segments respectively in pairs successively or in pairs simultaneously. The device for treating raw materials comprises generally at least two spaced apart electrodes, which are in contact with a controlled electrical energy source, wherein the electrodes are formed respectively by at least two electrically separated electrode segments, and each of said segments is connected to the electrical energy source in an electrically controlled manner and every electrode segment is connected to a measuring device installed between at least respectively two electrode segments to determine the electrical conductivity, wherein the electrical energy source is controlled by a control unit and the electrical energy source is controlled and set up in order to respectively apply electric energy at least to the two electrode segments, between which the lowest electrical conductivity is determined. Optionally, at least one of the electrodes is formed of at least two electrically separated electrode segments and the other of the electrodes can consist of one electrode segment so that one electrode is formed of at least two electrode segments and the other one consists of one electrode segment. Generally, the electrode segment surfaces are preferably identical in size. Generally, in particular with electrode segment surfaces of different sizes, the conductivity is preferably determined which results from the conductance in relation to the distance of the electrode segments and their surfaces, as conductance x electrode segment surface/distance of the electrode segments. Generally, the electrode segments are preferably set up to be arranged with the same pre-established force against the foodstuff raw material.

Unlike the formation of a current pathway between two spaced apart electrodes of previously known devices, the device according to the invention causes the formation of a multiplicity of current pathways which are formed through the foodstuff raw material in a controlled manner in three dimensions.

Due to the dependency of the conductance on the temperature of the raw material, electric energy is preferably applied to the electrode segments to heat up the raw material until the same electrical conductivity is achieved between all the combinatory pairs of electrode segments in relation to their distance, and preferably with a material-specific factor, wherein said electrical conductivity has preferably a prescribed target value which corresponds to a target temperature. This process control and the adaptation of the device to suit said method lie in that the electrical conductivity of the raw material corresponds to the temperature thereof so that the device preferably does not include any temperature sensor. Optionally, the device contains a temperature sensor whose sensor surface is arranged for instance between the electrode segments.

In case the raw material presents different structure areas, the measured conductivity for each of the structure areas is a benchmark for the temperature thereof, whereas preferably the measured electrical conductivity is converted with a material-specific factor so that the calculated electrical conductivity of each structure area of a raw material can have the same value and electric energy is applied in particular to the electrode segments, until said calculated electrical conductivity reaches the same value, preferably the target value between all the combinatory pairs of electrode segments. Accordingly, it is preferable in the case of pasty and solid raw materials to set up the device to apply electric energy to the electrode segments, until the same target value for electrical conductivity between all the combinatory pairs of electrode segments is reached for a material-specific factor.

For the purpose of the invention, the term conductance designates both the electrical conductivity for direct current and the conductivity for alternate current, also called admittance. Consequently, the term resistance encompasses both the resistance value in the presence of direct current and the resistance value in the presence of alternate current, also called impedance. Accordingly, a value for the conductivity for direct current or alternate current can optionally substitutionally be designated as a conductance.

The electrical conductivity (the conductance) can be determined directly by means of a conductance measuring device, or as a reciprocal of the resistance by means a resistance measuring device.

The electrode segments can be arranged in two parallel planes, spaced apart from one other, preferably parallel and span between them the cross-section in which a raw material is arranged. Alternately, the electrode segments can be arranged in a common plane and form for instance an inner surface for example of a cylinder or of an at least four-cornered section. Preferably, the electrode segments are arranged along a complete or self-contained circumference and span between them a cross-section so that the electrode segments enclose the cross-section around its whole circumference. The electrode segments arranged along the peripheral surface of said cross-section form between them a treatment chamber whose spaced apart terminal cross-sections can form an inlet opening and an opposite outlet opening, be sealed with an insulating material or likewise and be covered with electrode segments. Such a cross-section is preferably circular and the electrode segments arranged circumferentially delineate a cylindrical volume and form for instance a chamber closed at the extremities thereof and a channel open at the extremities thereof.

According to the invention, the device is set up to apply electric energy to the electrode segments respectively in pairs, which can be current, in particular an alternate current or a direct current and essentially causes the heating-up of the foodstuff and/or can include high-voltage pulses which generate a pulsed electric field and cause an at least partial structural modification of the foodstuff, for instance partial cell disintegration and/or germ reduction. Accordingly, the electrical energy source has a current source, in particular an alternate current source and/or a high-voltage pulse source.

A current source can have for instance a power from 1 to 150 kW, for instance from 10 to 35 kW, in particular from 15 to 25 kW. A high-voltage pulse source can for example be set up to generate high-voltage pulses with pulse powers of approx. 3-10 MW, in particular 5 MW, at a pulse duration of 10-30 μs, in particular 20 μs, at a duration of 3,000-5,000 μs between the pulses, in particular with a pulse interval of approx. 4,000 μs, for instance at an average power of approx. 15-50 kW, in particular approx. 25 kW.

The electrode segments are respectively in contact with the electrical energy source in a controlled manner wherein the electrical energy source is controlled by a control unit so that the electrical energy source is arranged to apply electric energy to the electrode segments in a controlled manner. The electrode segments are respectively connected to a measuring device to determine the electrical conductivity which is also designated as a conductance measuring device, which is set up to determine the electrical conductivity between the electrode segments. Preferably, the conductance measuring device is set up to determine the electrical conductivity between two electrode segments each, in particular between each combinatory pair of the electrode segments, preferably between electrode segments which are arranged in a common axial section of the chamber or of the channel, whose cross-section is spanned or delineated by the electrode segments. Preferably, the measuring device is set up to determine the electrical conductivity, to determine successively or simultaneously the electrical conductivity between every pair of electrode segments. According to the invention, it is preferably provided that the control unit applies electric energy to the same electrode segments in dependence from the electrical conductivity determined between the electrode segments by said measuring device, until a prescribed target value of the electric conductivity is achieved between these electrode segments.

In this manner, the process utilizes the dependency of the electrical conductivity which increases with the temperature to obtain a prescribed temperature along every current pathway in the process between electrode segments by applying electric energy, which pathway is generated between respectively two of the electrode segments. Optionally, in particular after at least one step of the determination of the electrical conductivity, electric energy is applied simultaneously to the electrode segments, between which the same electrical conductivity is determined with in relation to the distance of the electrode segments of the pair, in particular all the electrode segments, when, between all the combinatory pairs of electrode segments, the same electric conductivity is determined in relation to the distance of the electrode segments of the pair. The treatment with electric energy can be accelerated in this embodiment. A quantity of electric energy is preferably applied to the electrode segments, which quantity is a fraction of the energy which is sufficient to heat up the raw material maximally to the boiling temperature or is a fraction of the energy which is sufficient to achieve the desired grade of disintegration, in particular when the electric energy comprises or consists of high-voltage pulses. Such a fraction can amount at maximum to 90%, preferably at maximum 50%, more preferably at maximum 25%, at maximum 10% of the energy quantity which is sufficient to reach a cooking grade, the boiling temperature and/or the desired grade of cell disintegration.

The control device is preferably adapted to apply electric energy to the electrode segments, until reaching a prescribed target value of the electrical conductivity which can also be designated as target conductance, at least into two stages, whereas every stage of the value of the electrical conductivity is smaller than the prescribed target value. By setting up the control unit such that electric energy is applied to the electrode segments, until reaching respectively a first stage of the target value of the electrical conductivity for all the electrode segments, before electric energy is applied to the electrode segments to achieve a higher value of electrical conductivity, a more uniform treatment is reached, for example a heating process and/or a cell disintegration or germ reduction.

Optionally, the control unit can be set up so that the target value or the first or second stage thereof can be achieved by applying electric energy only to the electrode segments which are arranged at a distance of at maximum 75%, preferably at maximum 50%, more preferably at maximum 30% of the cross-section spanned by the electrode segments. In this form of embodiment, the device is in particular suitable for a process in which the foodstuff raw material is not traversed or heated up in its central region, or only up to the second or first stage by linear current pathways between the electrode segments spaced apart at least more than 75%, preferably more than 50%, more preferably more than 30% of the cross-section they span, for example for cooking meats as foodstuff raw materials, for which a central cross-section region must be cooked to a smaller extent.

The control device is more preferably set up to apply electric energy to the electrode segments, between which the lowest electric conductivity was determined with respect to the distance thereof, in particular with the same surface of the electrode segments. This can for example result from the fact that the value determined between two electrode segments for the electric conductivity is multiplied by the distance between the electrodes.

Preferably, the measuring device for determination of the electrical conductivity is a conductance measuring device which is connected simultaneously to the electrode segments for measuring purposes and is set up for measuring while electric energy is applied to the electrode segments by the control unit in a controlled manner so that the control unit interrupts the flow of electric energy between said electrode segments when reaching a prescribed value for the electric conductivity. Since the conductance measuring device is connected to all electrode segments, it is preferred that the conductance measuring device is set up for simultaneous determination of the electrical conductivity (conductances) between all the electrode segments, in particular between each combinatory pair of the electrode segments and that the control device is designed to apply electric energy to the pair of electrode segments respectively, between which the lowest value is determined for the electric conductivity. Especially preferred, the conductance measuring device is set up to determine the electrical conductivity for every combination of at least two electrode segments.

The device according to the invention on the one hand enables to gently apply electric energy to the raw material, in particular the foodstuff, a material which is arranged in the cross-section spanned between the electrode segments, for example for uniform heating thereof and/or partial cell desintegration or germ reduction. This is attributed to that the application of electric energy to the electrode segments via the control unit respectively so that a prescribed target value for the electrical conductivity (target conductance), in particular first of all a stage of a target conductance, whose conductance is smaller than the target conductance, reduces the formation of essentially one current pathway through the mass of foodstuff and generates a plurality of current conducting pathways through different sections of the cross-section of the foodstuff.

Additionally or alternatively to the set-up of the control unit or for controlling the electrical energy source through the control unit so that electric energy is applied to the electrode segments, between which the measuring device has determined the lowest electric conductivity, electrode segments, in particular electrode segments which are opposite to one another, can be supplied with electric energy regardless of the value of electrical conductivity. In this embodiment the electric energy has preferably an amount which is sufficient to heat up the raw material maximally to the boiling temperature, in particular an amount, which is at maximum 90%, preferably at maximum 50%, more preferably at maximum 25% or at maximum 10% of the energy amount, which causes the heating of the foodstuff to boiling temperature.

The lowest conductance or value of conductivity can be a conductance which is at maximum 90%, preferably at maximum 50%, more preferably at maximum 25% or at maximum 10% of the target conductance or the of stage thereof.

In a first embodiment, the electrode segments form at least a portion of the surface of a container or channel, into which foodstuffs are introduced, by way of example two spaced-apart wall sections which are opposite to each other. Preferably, the electrode segments form completely the inner surfaces of a container or of a channel, which extend at a distance around the longitudinal axis of the container or of the channel. When the spaced-apart front cross-sections are open and form an inlet opening and an opposite outlet opening for the passage of foodstuffs, the electrode segments encompass a channel. In this embodiment, the device is in particular suitable for a process of continuous production or heating of foodstuffs, which are moved along the longitudinal axis of the container or of the channel and through the device.

For the batchwise production of foodstuffs, the electrode segments, in a further embodiment, form the partial or complete inner surface of a container so that a foodstuff filled into the container is contacted at least by electrode segments in two spaced-apart planes, preferably by electrode segments from all sides so that the electrode segments in this embodiment completely surround the inner volume of the container.

In a further option, the electrode segments of every embodiment can be mounted rotatably and for instance be formed as rollers. Such rotatably mounted electrode segments can have a spherical shape or a roller shape, preferably with a convex surface and for example be rotary about an axis which is arranged tangentially to the cross-section spanned by the electrode segments or parallel to the peripheral surface delineated by the electrode segments.

The electrode segments are electrically insulated from each other by being spaced-apart from one another. An insulating material can be arranged between the electrode segments, in particular a synthetic material or ceramic suitable for foodstuffs. Alternatively, the electrode segments can be arranged on a carrier made up of an insulator and be spaced-apart from one another.

In a preferred embodiment, the electrode segments span a peripheral surface having a circular cross-section, wherein the peripheral surface respectively has frontally open cross-sections each, one of them forming an inlet opening and the other an outlet opening, in particular for continuously applying electric energy to foodstuffs. In an embodiment which is suitable in particular for continuously applying electric energy to foodstuffs, a first group of electrode segments is arranged in a first axial section along the periphery of a channel and at least one second group of electrode segments in a spaced-apart second axial section is situated along the periphery of the channel, wherein preferably the first and the second group of electrode segments enclose the same cross-section. The control unit is preferably set up to apply electric energy to the first group of electrode segments until reaching a first stage of a target conductance by means of the energy source, in particular between all the electrode segments of the first group, and is set up to apply electric energy to the second group of electrode segments by means of the energy source until reaching a second stage of the target conductance, which has a higher conductance than the first stage. By means of the axially spaced-apart arrangement of a first and of a second group of electrode segments which respectively enclose a section of a common channel, a uniform and gradual treatment of the foodstuff over the cross-section can be achieved by means of the controlled application of electric energy until reaching a first and a higher second stage of a target conductance, in particular a uniform gradual heating and/or a uniform gradual cell disintegration and/or a uniform gradual germ reduction.

Further preferably, the device contains a means for measuring the rate of cell disintegration, which for instance can be set up to control an electrical energy source which generates high-voltage pulses, in particular to control the process for generating high-voltage pulses until reaching a prescribed grade of cell disintegration. Preferably, the means for measuring the grade of cell disintegration is an impedance spectrometer, which e.g. is in contact with at least two or all the electrode segments spanning a cross-section between them.

Correspondingly, the method preferably includes the step of measuring the grade of cell disintegration and even more preferably the step of controlling the energy source for high-voltage pulses according to the measured grade of cell disintegration, in particular for generating high-voltage pulses until reaching a prescribed grade of cell disintegration. Preferably, the grade of cell disintegration is measured by means of impedance spectroscopy. Optionally, the control device is designed to control the electrical energy source in dependence from the measured values of the impedance spectroscopy, in particular to control for generating high-voltage pulses until a prescribed value is measured by means of impedance spectroscopy. In this embodiment the device or the process carried out thereby is devised for treating foodstuff raw materials until reaching a prescribed grade of cell disintegration which corresponds to the prescribed value which is measured by means of impedance spectroscopy.

Preferably, the surfaces of the electrode segments facing the foodstuff are convex in order to reduce the adhesion of foodstuffs or of a sheath enclosing the foodstuffs.

In a further option, the electrode segments can be provided with a cooling device, in particular internal cooling channels for passage of a cooling medium, channels which are connected to a source for cooling medium.

In an embodiment, which is suitable in particular for a process for continuous production of meats and sausages, which can optionally be contained in a sheath, the device includes on the side of the inlet opening which is spanned by the electrode segments, a means for feeding the foodstuff. Subsequent to the outlet opening opposite to the inlet opening, the device includes preferably a means of transport for the foodstuff having passed between the electrode segments, for instance a conveyor belt. Optionally, the electrode segments of every embodiment can be slidably mounted, for instance mobile vertically to the periphery spanned by the electrode segments. Therein, the electrode segments can be held for instance by carrier bars which are mobile along their longitudinal axis against the longitudinal axis of the periphery spanned by the electrode segments. In a method of production of foodstuffs by said embodiment, the foodstuff raw material is conveyed through the channel spanned by the electrode segments, preferably in a continuous manner. The electrode segments are preferably set up to be arranged with the same pre-determined force against the foodstuff raw material. Optionally, the electrode segments are fitted with a position sensor and/or a force sensor, for instance arranged on carrier bars which hold the electrode segments. The carrier bars can be mobile and guided linearly and are preferably fitted with a location sensor or a position sensor which is connected to the measuring device which is for example set up to determine the distances of the electrode segments with respect to each other from signals of the location sensor or position sensor and to use said distances for the determination of the electrical conductivity in realtion to said distances.

The position sensor can be a means of detection to determine the position of the electrode segments, for instance based on a laser measuring device or based on an ultrasound device. This is for example preferred when the electrode segments are mobile relative to one another, for example arranged on guided mobile carrier bars or on a deformable insulator. A deformable insulator can be for example a film of synthetic material, for instance of silicone polymer, on one surface of which the electrode segments are arranged. The deformable insulator is preferably sealable, for instance by means of a fastener to form a bag shape or by overlapping the insulator at least in edge regions. The deformable insulator can most preferably be evacuated, it can for instance be connected to a vacuum source so that the deformable insulator, fitted with the electrode segments disposed thereon, by evacuation is arranged on the raw material. In this embodiment, the deformable insulator, fitted with the electrode segments disposed on its surface, is preferably arranged in an insulator housing when electric energy is applied to the electrode segments.

In a further option, electrode segments can be arranged on a carrier mobile against the longitudinal axis of the spanned cross-section, by way of example on a flat or curved, in particular concave carrier plate so that the cross-section spanned between the electrode segments can be modified by moving the carrier.

Optionally, the device contains an optical detection device which displays the raw material and determines regions of different structure of the raw material. Such an optical detection device can for instance contain an optical camera which is set up to represent the raw material, or radioscopy device which is set up to X-ray and display the raw material.

The detection device contains preferably an interpretation unit which is set up for automatic recognition of structural regions and for allocating a material-specific factor of the electrical conductivity to every recognised structural region. Material-specific factors of the electrical conductivity represent the different temperature-dependent electrical conductivities of structural regions so that a measured electrical conductivity can be allocated to the temperature of the structural region by means of the material-specific factor. The interpretation unit is preferably connected to the control unit and the control unit is set up to process the electric conductivity measured between two electrodes, in particular with respect to the distance between the electrode segments, between which the electric conductivity is determined, with the material-specific factor to obtain a control signal with which the electrical energy source is controlled to energise the electrode segments. Preferably, the relationship between the measured electrical conductivity and the distance of the electrode segments is the multiplication product of the measured electrical conductivity with the distance of the affected electrode segments.

Optionally, the device contains a density measuring device which is set up to determine the density of the raw material, in particular of the raw material which is arranged between electrode segments. A density measuring device can be arranged on the cross-section spanned by the electrode segments. The density measuring device can be a volumetric, optical, acoustic or radiometric density measuring device, for instance a position feeler, an ultrasound densitometer or a radioscopy device or an infrared densitometer. The density measuring device is connected to the control unit for transmitting data in terms of density and the control unit is set up to apply electric energy to the electrode segments depending on the data in terms of density. The control device is set up for example to process the electric conductivity measured between two electrodes, in particular with respect to the distance between the electrode segments, between which the electric conductivity is determined, with the density data to obtain a control signal with which the electrical energy source is controlled to energise the electrode segments.

A material-specific factor of the electrical conductivity is preferably predetermined for instance by measuring the electrical conductivity of insulated homogeneous structural regions of a raw material between electrode segments in dependence from the application of electric energy to the electrode segments, in particular with the allocation of the material-specific factor to the temperature of the raw material. In this embodiment, a uniform treatment of a raw material is possible which contains different structural regions with different temperature-dependent electrical conductivities, since the electrode segments, between which the lowest electric conductivity is determined, in particular the lowest electric conductivity is determined with respect to their distance, which can be compared through the material-specific factor or which correspond to the same temperature of the raw material after conversion by the material-specific factor.

The device can find application as a cooking device and/or as a defrosting device in particular for raw, pre-cooked and/or frozen foodstuff raw material.

Optionally, the device contains a browning device which is arranged before and/or after the electrode segments and set up to warm up, in particular to heat up the surface of the foodstuff raw material superficially before and/or after application of electric energy, until a browning reaction takes place. A browning device can include heatable elements which are directed against the surface of the foodstuff raw material and contact this, for instance heated contact surfaces, or are arranged at a distance and warm them up, for instance by means of radiation when the browning device is embodied as a radiant heater. Alternatively or additionally, the browning device can be designed as a feeding unit for a heat transfer fluid in order to brown the surface of the foodstuff raw material by contact with the heat transfer fluid. Said feeding unit can be for instance a hot air blower and an oven and guide hot air, a feeding unit for hot water or hot fat to the foodstuff raw material, and/or be a burner whose flame is oriented for instance to the foodstuff raw material. The browning device can be formed as a heating device for electrode segments so that the electrode segments brown superficially by contact to the surface of the foodstuff raw material.

### DETAILED DESCRIPTION OF THE INVENTION

The invention will now be described more precisely with reference to the following figures which schematically show

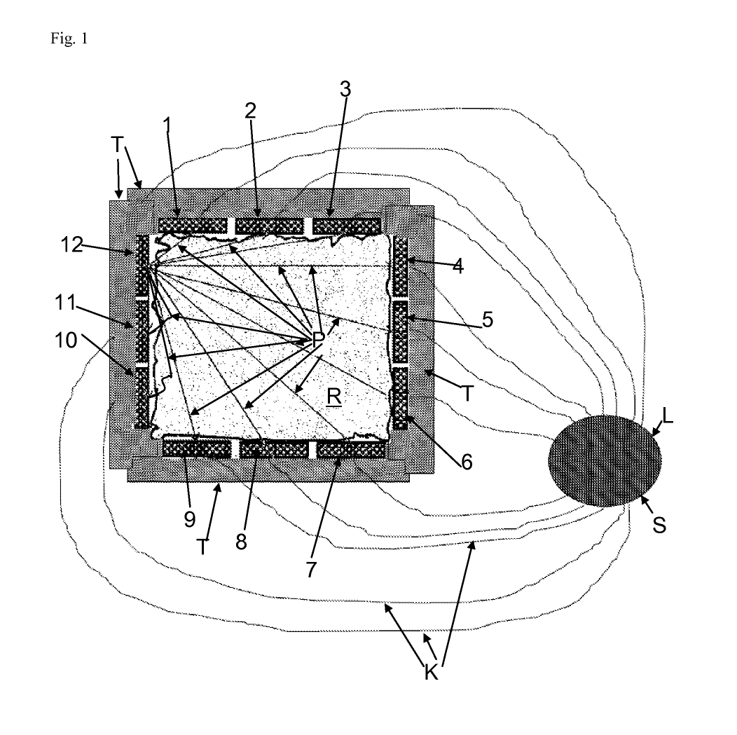

in FIG. 1 a sectional view of the device according to the invention,

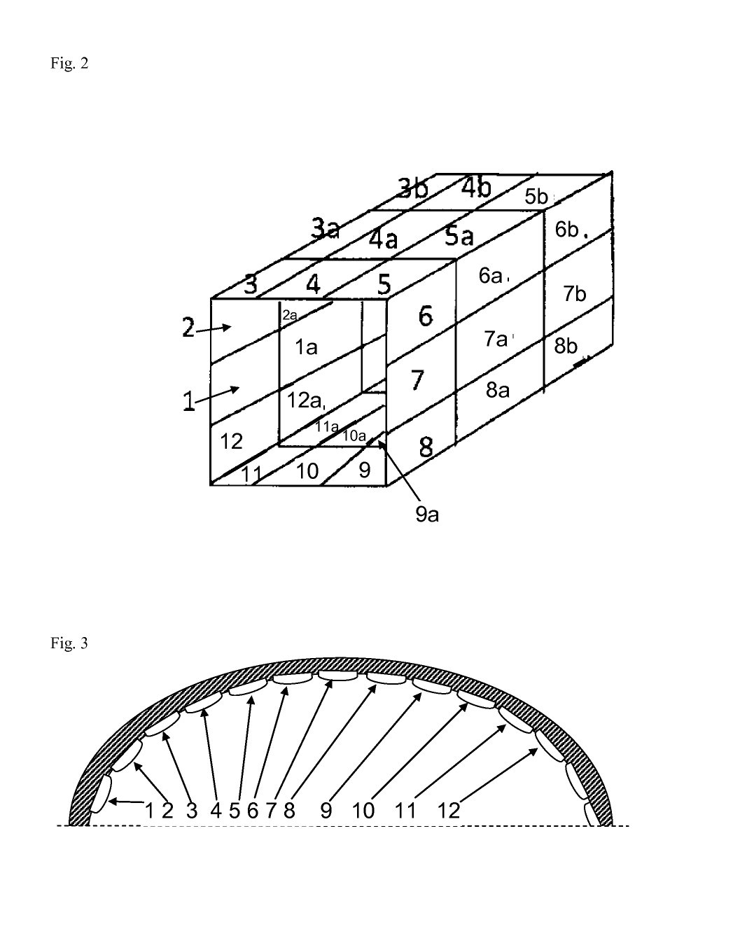

in FIG. 2 a device which is suited in particular for a continuous method,

in FIG. 3 an example of an arrangement of electrode segments,

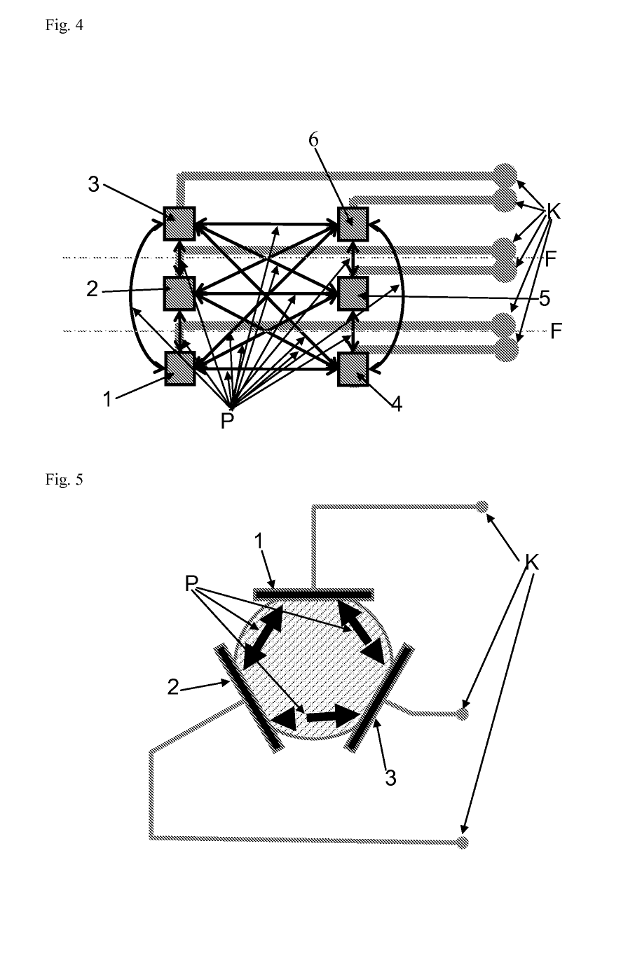

in FIG. 4 an unfolded illustration of an arrangement of the electrode segments,

in FIG. 5 a further embodiment of the arrangement of the electrode segments in cross section and

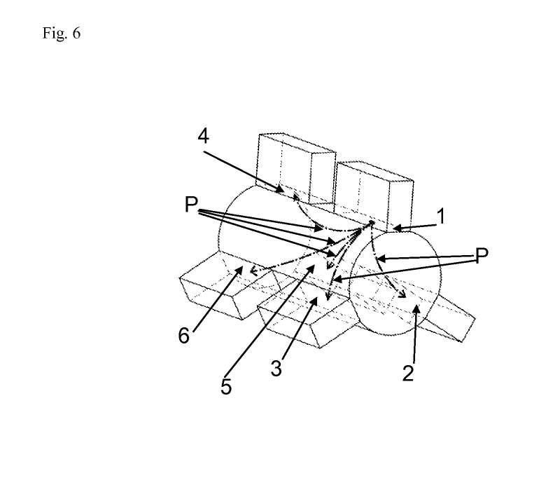

in FIG. 6 an embodiment in perspective representation.

Like reference numerals in the figures designate functionally equal elements. For the purpose of the invention, the description of the set up of the device designates at the same time the steps of the method which can be carried out with the device. The reference to a current source encompasses an alternate current source and alternately a direct current source and is representative of an electrical energy source which can alternatively be a high-voltage pulse source or can additionally comprise a high-voltage pulse source.

FIG. 1 schematically shows the device in the cross-section which is spanned by the representatively designated electrode segments 1-12, wherein a raw material is arranged in the cross-section as a foodstuff to be treated R. For electrical insulation purposes, the electrode segments 1-12 are spaced apart from one another and are arranged on a carrier T made of insulating material. The insulating material of the carrier T can extend into the clearances between the electrodes 1-12 so that preferably the electrode segments 1-12 are arranged on a carrier T and that a continuous surface is formed by the electrode segments 1-12 and material of the carrier T arranged between these.

The electrode segments 1-12 are respectively connected to a current source S by means of conductors, which current source is set up to apply current to the electrode segments 1-12 in a controlled manner.

Moreover, every electrode segment 1-12 is connected with a conductance measuring device L which is set up to determine the values of electrical conductivity of the foodstuff R arranged in the cross-section spanned between the electrode segments 1-12, between the electrode segments 1-12, in particular between every two of the electrode segments 1-12. The conductance measuring device L can generally be connected to the electrode segments by means of conductors 1-12, which are present in addition to the conductors K, by means of which the current source S supplies current to the electrode segments 1-12. Alternatively, the conductance measuring device L can generally be connected to the electrode segments 1-12 by means of the same conductors, with which the current source S is connected to the electrode segments 1-12. The conductance measuring device is for instance a measuring device set up to determine the conductivity inasmuch as the measured values are set with reference to the electrode segment surface and to the distance of the electrode segments, for example as a measured value of the conductance x electrode segment surface/distance of the electrode segments.

FIG. 1 represents schematically possible current pathways P, and the electrode segments 1-12 are connected through current pathways P respectively which are generated by the electrode segments 1-12 being supplied with current of opposite polarity in a controlled manner, in pairs and simultaneously by the current source S. A possible temporal sequence of the application of current to the electrode segments 1-12 is indicated by the plurality of current pathways P since they are generated chronologically after one another by the electrode segments 1-12 forming respectively a current pathway P are supplied with current of opposite polarity by the current source S in a controlled manner, for example the electrode segments 1-12 subsequently are connected to one another in pairs by the current pathways P arranged in the figure from top to bottom.

FIG. 2 shows the arrangement of electrode segments 1-12, 1a-12a, 1b-12b, as far as they can be seen in perspective representation, which between them enclose a square cross-section and form completely the peripheral surface for said cross-section. The frontal cross-sections can be open at the extremities thereof, as depicted on FIG. 2 and form an inlet opening and opposite thereto an outlet opening for the passage of foodstuffs through, in particular for a continuous method of production of foodstuffs with the step of warming up the foodstuff during continuous passage through the cross-section, which is spanned by the electrode segments 1-12, 1a-12, 1b-12b. According to a preferred embodiment, the cross-section is completely formed by spaced-apart electrode segments 1-12 arranged side by side, wherein the electrode segments 1-12 extend perpendicular to the cross-section and most preferably the electrodes are formed respectively by electrode segments 1-12a or 1b-12b also along the axis perpendicular to the spanned cross-section. Therein, the electrode segments 1-12 form a first group of electrode segments and the electrode segments 1a-12a from a second group of electrode segments, as well as the electrode segments 1b-12b from a further second group of electrode segments, wherein every group of electrode segments 1-12, 1a-12a or 1b-12b in an axial section is arranged around the same cross-section or the same channel.

FIG. 3 shows a sectional cut of a portion of a channel which is spanned by spaced apart electrodes 1 to 12. The electrode segments are connected to a measuring device for the measurement of conductivity and to an electrical energy source which is controlled by a control unit, respectively to apply energy to the electrode segments, between which the lowest conductance was determined with relation to the electrode segment surfaces and their distance.

FIG. 4 shows in a representation unfolded along the folding lines F the electrode segments 1 to 6, which between them enclose a cross-section of a channel. The plurality of the current pathways P, which is generated by applying electricity to the electrode segments respectively, between which the lowest electric conductivity is measured, causes regular warming-up of the foodstuff raw material arranged between the electrode segments.

FIG. 5 shows an f embodiment in which one electrode consists of a segment 1 and the other electrode is divided in 2 segments 2, 3 so that the device presents as a whole three electrode segments 1, 2, 3 where electric energy is applied to the electrode segments between which the smallest conductivity is measured. The indicated current pathways P indicate that a foodstuff raw material abutting against the electrodes is warmed homogeneously at least in the edge region. Electric contacts K for connecting the electrical energy source are respectively led through to the right in FIGS. 4 and 5.

FIG. 6 shows schematically in total six electrode segments 1-6 of which three each are arranged in axial sections of a cylindrical channel. The electrode segments 1-6 can as shown be arranged with the same radial offset or alternately with an offset between the electrode segments 1-3 or 4-6, which are arranged in an axial section of the channel. The electrode segments 1-3 or 4-6, arranged in an axial section, are preferably arranged respectively at the same distance from each other. The possible current pathways P are shown by way of example for the combinations of an electrode segment 1.

The figures show clearly that generally due to the formation of one or every electrode as at least 2 segments, which are spaced-apart from one other and the control unit is set up to apply energy to the electrode segments independently from one another, between which the lowest electric conductivity is measured, a plurality of current pathways is inserted through the raw material and a uniform energy supply for warming-up is achieved in spite of the modification of conductivity due to said warming-up.

### Example 1

### Production of Meats and Sausages

A device according to the invention, which contains 12 and in a preferred variation 24 or 48 electrode segments, of which 6 or 12 or 24 respectively were adjoining against one another around a common circular cross-section in respectively one axial section and formed a cylinder open on both sides, was used for warming-up pieces of meat or sausage meat which respectively were contained in a sheath of circular cross-section. The electrode segments accordingly formed a first and a second axially spaced-apart group of electrode segments. The electrode segments were arranged in respectively two rows according to their axial distance on two carriers in the form of semi-shells, which could be pivoted relative to one another so as to open the circular cross-section, to insert the sheathed foodstuffs and to close it. The respective frontal cross-sections were either covered with an insulator or with electrode segments.

The electrode segments were connected to a current source by means of conductors, which applied current to the electrode segments in pairs in dependence on the conductance measured between a pair of electrode segments. The electrode segments were connected each to the current source by means of a conductor. The conductors were connected also to a conductance measuring device which was set up to determine the conductance between respectively two electrode segments and preferably to put it into relation to the surface of the electrode segments and their distance. The conductance measuring device was coupled to the current source by means of a control unit so that the current source in dependence on the conductances generated by the conductance measuring device applied current to the electrode segments in pairs each, between which the smallest conductance was measured. Alternatively, current was applied to the electrode segments in pairs each, between which the lowest conductance was determined as calculated as a product from the distance of the electrode segments and the conductance measured between them.

Therein, the application of current was applied to the electrode segments respectively until reaching a prescribed conductance until said conductance was determined for all pairs of electrode segments by the conductance measuring device.

Alternatively, the current source was set up in such a way that it applied current to the electrode segments of the first and of the second group until a prescribed first stage of the target conductance was reached for them. Said first stage of the target conductance could for instance amount to 10 to 80%, preferably 20 to 50% of the predetermined target conductance. Only after application of current to the electrode segments of the first and of the second group respectively in pairs until reaching the first stage of the target conductance between all the pairs of the electrode segments current was subsequently applied respectively to the electrode segments in pairs, until the target conductance or a second higher stage of the target conductance was determined. Thereby, a uniform and rapid warm-up of the foodstuff arranged in the cross-section between the electrode segments was achieved.

### Example 2

### Continuous Production of a Foodstuff

A device was used according to example 1 for the continuous production of a foodstuff by warming-up for which the terminal cross-sections spanned by the electrode segments were open and formed an inlet opening and an opposite outlet opening. Sausage meat in a sheath was transported as a foodstuff continuously through the inlet opening and after passing through the cross-section spanned by the electrode segments exited the outlet opening. In said embodiment, electrode segments are preferably arranged in at least two, more preferably at least three axially spaced apart groups of electrode segments, which respectively span the same cross-section along a common axis. Such a device inasmuch corresponded to the arrangement of electrode segments of FIG. 2 as axially spaced apart electrode segments 1-12, 1a-12a and 1b-12b respectively in an axial section formed a closed circumference and spanned a passing cross-section, preferably a circular cross-section.

According to the specifically preferable embodiment, the current source was optionally set up to apply current in a controlled manner to the first group, arranged in a first axial section, of electrode segments 1-12, as shown in FIG. 2, so that a first stage of the target conductance was achieved in the first axial section and the neighbouring second group of electrode segments 1a-12a, which comprises the neighbouring axial section of the channel, was respectively supplied with current until a second higher stage of the target conductance was determined between the electrode segments of the second group. The electrode segments of the further second group 1b-12b of the neighbouring axial section was applied current accordingly in a controlled manner until the target conductance was reached between said electrode segments.

This example has also shown that the device according to the invention enables a rapid and uniform as well as gentle warming-up of a foodstuff over the whole cross-section thereof.

### Example 3

### Treatment of a Chunky Raw Material

A piece of meat was used as an example for a raw material with different structural regions, a piece of meat with presented a region of connective tissue, a region of muscular flesh and a fat layer as a superficial region.

To determine material-specific factors of electrical conductivity, homogeneous discs of the different structural regions were insulated from a comparable piece of meat and applied with alternate current between spaced apart electrodes continuously or with interruptions, while the electrical conductivity and the temperature were measured. Optionally, these material-specific factors were standardised by dividing the measured electrical conductivity through the distance of the electrode segments and by the relation to the electrical conductivity of a homogeneous structural region thereto. Preferably, this material-specific factor was determined in dependence on the temperature or for every temperature.

A radioscopy device and alternatively or additionally an optical camera was used an as optical detection device which contained an interpretation unit and was set up to determine geometric data of the different structural regions in the picture taken and to allocate respectively the material-specific factor to said structural regions.

The interpretation unit was set up for transmitting the geometrical data of the structural regions and material-specific factors allocated to these to the control unit. The control unit was set up to apply current and/or high-voltage pulses to those electrode segments by means of the electrical energy source which adjoined the respective structural regions upon arrangement of the raw material between the electrode segments and presented the lowest electrical conductivity. Therein, the electrical conductivity was determined in relation to the distance of the energised electrode segments by means of the material-specific factor so that a homogeneous treatment resulted for the raw material meat over its whole cross-section.

1. Device for treating raw materials comprising at least two spaced apart electrodes, which are in contact with a controlled electrical energy source, characterized in that the electrodes are formed by at least two electrically separated electrode segments (1-12, 1a-12a, 1b-12b), to which electric energy can be applied in an electrically separated manner, each of said segments is connected to the electrical energy source (6) in an electrically controlled manner and every electrode segment (1-12, 1a-12a, 1b-12b) is connected to a measuring device (7) for determination of the electrical conductivity between electrode segments (1-12, 1a-12a, 1b-12b), wherein the electrical energy source (6) is controlled by a control unit and is set up to respectively apply electric energy at least to the two electrode segments (1-12, 1a-12a, 1b-12b) between which the lowest electrical conductivity is determined.

2. Device according to claim 1, characterized in that the electrical energy source (6) is controlled by the control unit, in that electric energy is applied to the electrode segments (1-12, 1a-12a, 1b-12b) between which the lowest electrical conductivity is determined in relation to the distance between the electrode segments (1-12, 1a-12a, 1b-12b).

3. Device according to claim 1, characterized in that one of the electrodes is formed by one electrode segment and the other of the electrodes is formed by at least two electrode segments and the measuring device (7) is set up to determine the conductivity between all the electrode segments

4. Device according to claim 1, characterized in that the measuring device (7) is set up to determine the electrical conductivity for every combinatory pair of electrode segments (1-12, 1a-12a, 1b-12b

5. Device according claim 1, characterized in that the electrical energy source (6) includes an alternate current source, a direct current source and/or a high-voltage pulse source

6. Device according to claim 1, characterized in that the electrode segments (1-12, 1a-12a, 1b-12b) form a circumferential surface which forms a channel of constant cross-section for arranging the raw material.

7. Device according to claim 1, characterized in that the cross-section spanned by the electrode segments (1-12, 1a-12a, 1b-12b) forms at one end an inlet opening and at the other end an outlet opening.

8. Device according to claim 1, characterized in that the cross-section spanned by the electrode segments (1-12, 1a-12a, 1b-12b) is respectively covered at its ends by at least 3 to at least 12 electrode segments.

9. Device according claim 6, characterized in that the electrode segments (1-12, 1a-12a, 1b-12b) are respectively rotatably mounted about an axis.

10. Device according to claim 1, characterized in that the control device is set up to apply electric energy to the electrode segments (1-12, 1a-12a, 1b-12b) until reaching a predefined target value of the electrical conductivity, a value which is established between every pair of the electrode segments (1-12, 1a-12a, 1b-12b).

11. Device according to claim 1, characterized in that the control device is designed to respectively apply electric energy periodically to two electrode segments (1-12, 1a-12a, 1b-12b), until a predefined target value is achieved for the electrical conductivity, for every combinatory pair of electrode segments (1-12, 1a-12a, 1b-12b).

12. Device according to claim 1, characterized in that the control unit is set up to reach the predefined target value for the electrical conductivity in at least two stages, wherein electric energy is applied to the electrode segments (1-12, 1a-12a, 1b-12b) until reaching a stage of the target value for the electrical conductivity and subsequently electric energy is applied to the electrode segments (1-12, 1a-12a, 1b-12b) until reaching a second target value for the electrical conductivity, a value which is higher than the first target value for the electrical conductivity.

13. Device according to claim 1, characterized in that a feeding device for foodstuffs is arranged at the inlet opening leading to the cross-section which is spanned between the electrode segments (1-12, 1a-12a, 1b-12b) and a transportation device is arranged on the outlet opening of the cross-section opposite to the inlet opening.

14. Device according to claim 1, characterized in that the electrode segments (1-12, 1a-12a, 1b-12b) are arranged in a first group (1-12) and in at least a second group (1-12, 1a-12a, 1b-12b) which respectively form the circumference of a channel and are spaced apart along the axis of the channel.

15. Device according to claim 14, characterized in that the control device is set up to apply electric energy to the electrode segments (1-12) of the first group until reaching a first stage of the target value for the electrical conductivity and the control device is set up to apply electric energy to the electrode segments (1a-12a, 1b-12b) of a second group until reaching a higher, second stage of the target value for the electrical conductivity.

16. Device according to claim 1, characterized in that it comprises an impedance spectrometer and that the control device is set up to control the electrical energy source in dependence on the measuring value of the impedance spectrometer.

17. Device according to claim 1, characterized by an optical detection device, the detection area of which includes a location in which the raw material can be arranged, with an interpretation unit which is set up to recognise structure areas of the raw material and the geometrical data of said structure areas and is set up to associate material-specific factors for the electrical conductivity to the structure areas and to transfer the association of the material-specific factors for the electrical conductivity in combination with the geometrical data of the structure areas to the control unit, wherein the control unit is designed to apply electric energy to the electrode segments, which with the material-specific factor present the lowest electrical conductivity and adjoin the structure areas.

18. Device according to claim 1, characterized in that the electrode segments are slidably mounted and are set up to be arranged with the same pre-determined force against the foodstuff raw material.

19. Device according to claim 1, characterized in that it includes a browning device which is a radiant heater, heated contact surfaces and/or is a flame and/or a feeding unit for a heat transfer fluid, which is directed onto the surface of the foodstuff raw material.

20. Device according to claim 1, characterized in that the electrode segments (1-12, 1a-12a, 1b-12b) are arranged on a deformable insulator or on movable carriers.

21. Device according to claim 1, characterized by a device to determination of the position of the electrode segments (1-12, 1a-12a, 1b-12b), which is connected to the measuring device (7), wherein the measuring device (7) is set up to determine the conductivity between electrode segments (1-12, 1a-12a, 1b-12b) in relation to their distances.

22. Device according to claim 1, characterized by a density measuring device, which is connected to the control unit for transmitting data relating to the density of the raw material, wherein the control unit is set up to apply electric energy electrode segments according to the data relating to the density.

23. Method for producing a foodstuff with the step of applying electric energy to a foodstuff raw material, characterized in that electric energy is applied to the foodstuff inside a device according to claim 1, wherein the electrical conductivity is determined between each two of the electrode segments (1-12, 1a-12a, 1b-12b) and electric energy is applied to the two electrode segments (1-12, 1a-12a, 1b-12b) each in a controlled manner between which the lowest electrical conductivity is determined in relation to their distance.

24. Method of claim 23, characterized in that the foodstuff is conveyed continuously through the cross-section which is spanned by the electrode segments (1-12, 1a-12, 1b-12b).

25. Method according to claim 23, characterized in that electric energy is applied to the electrode segments (1-12) which are arranged in a first axial section of the device until a first target value of the electrical conductivity is reached for every combinatory pair of electrode segments (1-12) and that electric energy is applied to the electrode segments (1a-12a, 1b-12b) which are arranged in a second axial section of the device adjoining the first axial section until a second target value of the electrical conductivity is reached for pairs of electrode segments (1a-12a, 1b-12b), which is higher than the first target value.
